(19) United States
(12) Patent Application Publication
(10) Pub. No.: US 2008/0087060 A1
(43) Pub. Date: Apr. 17, 2008

(54) Lock body assembly, clip and cam assembly

(75) Inventor: Simon James Butt, Moorebank NSW (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: TNBT Holdings Pty Limited, Moscot (AU)

(21) Appl. No.: 11/818,874

(22) Filed: Jun. 15, 2007

Related U.S. Application Data
(63) Continuation-in-part of application No. PCT/AU05/01889, filed on Dec. 15, 2005.

(30) Foreign Application Priority Data
Dec. 16, 2004 (AU) 2004907154

(51) Int. Cl. E05B 27/04

(52) U.S. Cl. 70/358

(57) ABSTRACT

The invention provides a lock body assembly (10A) suitable for a double lock barrel assembly having two lock barrels (12). The assembly (10A) has a main body (14A) for receipt of a lock barrel (12) and a plurality of pin tumbler passages (16). Each pin tumbler passage (16) communicates at one end with the main body (14A) and is open at the other end. Closing off means (30) closes off the other ends of the pin tumbler passages (16).

### CROSS-REFERENCES TO RELATED APPLICATIONS

The present application is a continuation-in-part of PCT/AU2005/001889 published in English and designating the US, filed Dec. 15, 2005, which claims priority under 35 USC 119 from AU 2004907154, filed Dec. 16, 2004, both of which are incorporated by reference in their entirety for all purposes.

### STATEMENT AS TO RIGHTS TO INVENTIONS MADE UNDER FEDERALLY SPONSORED RESEARCH OR DEVELOPMENT

Not applicable

### REFERENCE TO A “SEQUENCE LISTING,” A TABLE, OR A COMPUTER PROGRAM LISTING APPENDIX SUBMITTED ON A COMPACT DISK.

Not applicable

### FIELD OF THE INVENTION

This invention is concerned with a lock body assembly for a double lock barrel assembly.

### BACKGROUND OF THE INVENTION

The invention in its various aspects has been designed for a double lock barrel assembly which can be installed in a door, for example, and enable keyed access from either side, usually operating a centrally located latch mechanism.

### BRIEF SUMMARY OF THE INVENTION

The invention provides a lock body assembly (10A) suitable for a double lock barrel assembly having two lock barrels (12). The assembly (10A) has a main body (14A) for receipt of a lock barrel (12) and a plurality of pin tumbler passages (16). Each pin tumbler passage (16) communicates at one end with the main body (14A) and is open at the other end. Closing off means (30) closes off the other ends of the pin tumbler passages (16).

Also included is connecting means (44) for connecting the closing off means (30) with a second closing off means (30) for a second lock body assembly (10B).

The invention also discloses a clip (100) for securing the lock barrel (12) in the lock body assembly (10A). The lock barrel (12) includes a peripheral channel (96) adapted to receive the clip (100) when the lock barrel (12) is inserted in the main body (14A). The clip (100) includes an extension (98) for rotating the clip (100) between a first position in which the extension (98) protrudes from the body (14A) and a second position in which the extension (98) does not so protrude.

The invention also provides a cam assembly for a double lock barrel assembly. The cam assembly has a first adjustable cam part (116) and a second adjustable cam part (108) adapted for engagement with a first adjustable cam part (116). Either the first (116) or the second (108) adjustable cam part includes latch actuation means. The first adjustable cam part (116) is capable of assembly in more than one configuration in relation to the second adjustable cam part (108).

### BRIEF DESCRIPTION OF THE DRAWINGS

The various aspects of the invention will now be described in connection with certain non-limiting examples thereof as illustrated in the accompanying drawings, in which:

FIG. 1 is an exploded perspective view of a first embodiment of a lock body assembly of the invention, showing also an embodiment of the clip of the invention and an embodiment of the cam assembly of the invention;

FIG. 2 shows the embodiment of FIG. 1 in assembled form;

FIG. 3 is an exploded perspective view of a second embodiment of the lock body assembly of the invention, including a cap;

FIG. 4 shows part of the second embodiment in FIG. 3 in assembled form;

FIG. 5 is an exploded perspective view of a third embodiment of the lock body assembly of the invention, including a cap, showing also a second embodiment of the clip of the invention;

FIG. 6 shows in perspective view a stage in production of the lock body assembly of FIG. 5;

FIG. 7 shows the next stage in production, after machining of the part of assembly shown in FIG. 6;

FIG. 8 is a perspective view of half of the lock body assembly of FIG. 5, assembled and in a larger scale;

FIG. 9 is a perspective view of the assembled lock body assembly of FIGS. 5 to 8, without the cap;

FIG. 10 shows the assembly of FIG. 9, with the cap;

FIG. 11 is a perspective view of an embodiment of the first adjustable cam part of the cam assembly of the invention, being the same as that featured in FIGS. 1 and 2;

FIG. 12 is a plan view of the first adjustable cam part of FIG. 11;

FIG. 13 is a perspective view of the second adjustable cam part which is also featured in FIGS. 1 and 2;

FIG. 14 is a plan view of the second adjustable cam part of FIG. 13;

FIG. 15 is an exploded perspective view of a further embodiment of a lock body assembly of the invention;

FIG. 16 shows the embodiment of FIG. 15 (rotated through 180o) in assembled form without the cap;

FIG. 17 shows the embodiment of FIGS. 15 and 16 with the cap in place; and

FIG. 18 is a perspective view of the assembly of FIGS. 15 to 17, showing the cap removed and with one of the lock barrels within its main body pivoted for dismantling.

### DETAILED DESCRIPTION OF THE INVENTION

In one aspect, this invention deals with a lock body assembly for a double lock barrel assembly. In a second aspect, the invention deals with a clip suitable for use with a double lock barrel assembly. In a third aspect, this invention deals with a cam assembly which can be adjusted so that it can be located in a variety of rotational positions.

Accordingly, in a first aspect, this invention provides a lock body assembly for a double lock barrel assembly, the lock body assembly including:

a) a main body for receipt of a first lock barrel;

b) a plurality of pin tumbler passages, each communicating at one end with the main body and being open at the other end;

c) means for closing off the other end of the pin tumbler passages; and

d) means for connecting the closing off means with a second closing off means for a second lock body assembly.

It is preferred that the lock body assembly of the invention in its first aspect is one of a pair of lock body assemblies. In this embodiment, the second lock body assembly has a second main body for receipt of a second lock barrel. The second lock body assembly includes a plurality of pin tumbler passages, each communicating at one end with the second main body and being open at the other end. The second lock body assembly includes the second means for closing off the other end of the pin tumbler passages.

The closing off means may be made of any suitable material but is preferably of machined stainless steel. Similarly, the connecting means is preferably also machined from stainless steel. The closing off means preferably closes off all of the other end of the pin tumbler passages. The closing off means may be the same as or different from the second closing off means.

The main body is made of any suitable material. Preferably, it is extruded from brass. It is preferred that the pin tumbler passages are contained within a block attached to or formed with the main body.

It is preferred that a cap is provided for the lock body assembly of the first aspect of the invention. It is especially preferred that the cap covers the closing off means for the first and second lock body assemblies. Preferably, the cap is in one piece. The cap may be made from any suitable material but preferably is die cast from zinc and plated to the required finish.

The closing off means may take any suitable form. In one embodiment, the closing off means is generally cylindrical and designed to slide into an arcuate channel with which the other end of the pin tumbler passages communicate. In this embodiment, the closing off means preferably has a tongue with an aperture. The tongue is designed to mate with a similar tongue on the connecting means. In this embodiment, the tongue of the connecting means also contains an aperture. The aperture on the connecting means can line up with the aperture of the closing off means and both can be secured together by means of a screw. It is especially preferred that the same screw secures the cap to the connecting means and closing off means. It is further preferred that the apertures do not line up with any of the pin tumbler passages, although the apertures may be positioned between two adjacent pin tumbler passages and even overlap them.

In a second preferred embodiment, the closing off means is generally cylindrical with a central bore which can receive a cylindrical projection on the connecting means. In this embodiment, it is preferred that the closing off means can be slidably attached to a block containing the plurality of pin tumbler passages by a pair of tongue and groove arrangements.

In a third preferred embodiment, the closing off means is different from the second closing off means. In this embodiment, the (first) closing off means is generally partly a first rectangular parallelopiped and partly a second rectangular parallelopiped rotated through 90o from the first rectangular parallelopiped. The second closing off means in this embodiment is a generally flat piece, optionally with side walls for securing purposes. In this embodiment, it is preferred that the connecting means is integral with the (first) closing off means.

Examples of the preferred embodiments are shown in the accompanying drawings.

To facilitate dismantling of the lock body assembly of the invention, in one preferred embodiment one of the lock body assemblies in a double lock barrel assembly can be partly released from the double lock barrel assembly in order to pivot away from the remaining double lock barrel assembly. This embodiment can be particularly useful in facilitating access for rekeying of one or both of the lock barrels.

In its second aspect, this invention provides a clip for securing a lock barrel in a lock body assembly, the lock barrel being adapted for receipt within a main body of the lock body assembly, the lock barrel including a peripheral channel adapted to receive the clip when the lock barrel is inserted in the main body, wherein the clip includes an extension for rotating the clip between a first position in which the extension protrudes from the main body and a second position in which the extension does not so protrude.

Preferably, the channel on the lock barrel extends for most or all of the circumference of the lock barrel. It is preferred that the clip is roughly “Y” shaped, the region between the arms of the “Y” being approximately a little more than semi-circular. During assembly of the lock barrel into the lock body assembly, the clip may be easily manipulated by holding the projection, in order to secure the lock barrel within the main body. Once the lock barrel is secured, the projection can be rotated out of the way into the silhouette of the lock body. Preferably, the projection is held in this configuration by the cap, if used. The projection may also be held in this position by the connecting means, which may include a suitable surface, such as a flat, for this purpose. To disassemble the lock barrel from the lock body assembly, when the cap is removed the projection may rotate under the influence of gravity. The projection can then be gripped and the clip withdrawn from engagement with the channel. It will be appreciated by one skilled in the art that this is a far superior clip to the conventional circlip, which can be difficult to access and difficult to remove from the assembly.

The clip may be made of any suitable material but preferably is punched from spring steel.

In its third aspect, this invention provides a cam assembly for a double lock barrel assembly, the cam assembly including:

a) a first adjustable cam part; and

b) a second adjustable cam part adapted for engagement with the first adjustable cam part;

Either the first or the second adjustable cam part including latch actuation means, wherein the first adjustable cam part is capable of assembly in more than one configuration in relation to the second adjustable cam part.

The cam assembly of the third aspect of the invention is particularly suitable for use with the lock body assembly of the first aspect of the invention and the clip of the second aspect of the invention. However, it is to be understood that each aspect may be used independently.

The cam assembly may take the form of a fixed cam, a floating cam or any other suitable configuration.

In one embodiment, the first adjustable cam part is adapted for engagement with an inner cam part of the type which is readily available on the market. However, the first adjustable cam part may be adapted for engagement with the second adjustable cam part without inclusion of the known inner cam part.

Each of the cam parts may be made from any suitable material, especially sintered. If desired, one or more of the cam parts may be oil impregnated to reduce corrosion.

The first adjustable cam part is preferably shaped so that it can be assembled in more than one configuration in relation to both the inner cam part (if present) and the second adjustable cam part. It is especially preferred that the first adjustable cam part is capable of assembly with the second adjustable cam part in different rotational positions.

### DETAILED DESCRIPTION OF THE DRAWINGS

Referring first to FIGS. I and 2, the first lock body assembly 10A and second lock body assembly 10B are shown in the context of a double lock barrel assembly. Each lock barrel assembly includes a lock barrel 12 rotatably received in first main body 14A and second main body 14B. Each lock barrel 12 has six pin tumbler passages 16. When lock barrel 12 is inserted in place within main body 14A or main body 14B, each of pin tumbler passages 16 mates with a corresponding pin tumbler passage 18, only one of which can be seen in each of block 64. Each of pin tumbler passages 18 communicates at the lower end with cavity 20 in main body 14A and 14B and is open at the upper end. Upper pin parts 22 and lower pin parts 24 are loaded into pin tumbler passages 18 and 16 and biased by spring 26, in known manner.

Each block 64 includes arcuate channel 28. Closing off means 30 is designed to slide into arcuate channel 28 until further travel is prevented by ridge 32. In this configuration, bar 34 and flat 40 of closing off means 30 covers the six pin tumbler passages 18. Aperture 36 lies between the fifth and sixth pin tumbler passage 18 and is eventually secured by screw 38 as explained below.

Flat 40 of closing off means 30 is adapted to fit under and mate with flat 42 of connecting means 44. In this configuration, aperture 46 lines up with aperture 36. In this way, main body 14A, closing off means 30 and connecting means 44 are connected together and secured when screw 38 is inserted later (see below).

Likewise, main body 14B is assembled with closing off means 30 and connecting means 44, being secured together by screw 48 (see below) later inserted through apertures 46 and 36.

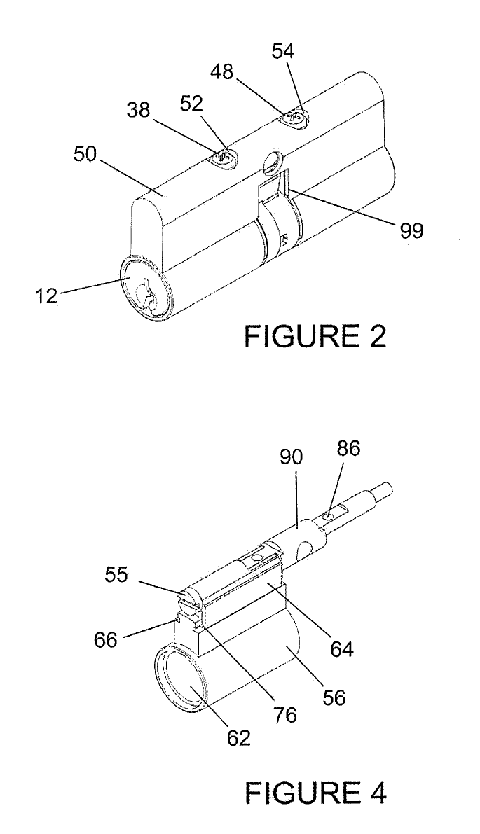

As shown in FIG. 2, in the complete assembly, cap 50 is put in place to cover closing off means 30 in arcuate channel 28 and connecting means 44. Screw 38 is inserted through aperture 52 in cap 50 and then into apertures 46 and 36 as described above. Screw 48 is inserted in aperture 54 in cap 50 and then into apertures 46 and 36 as referred to above.

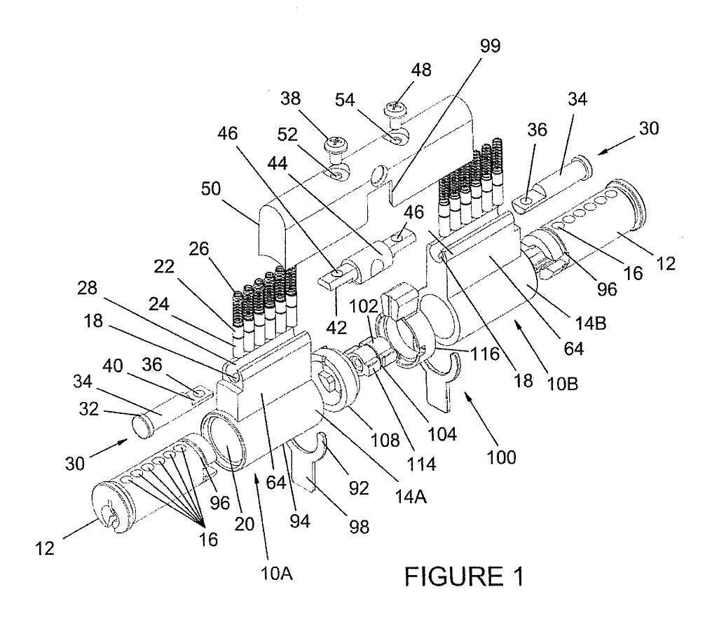

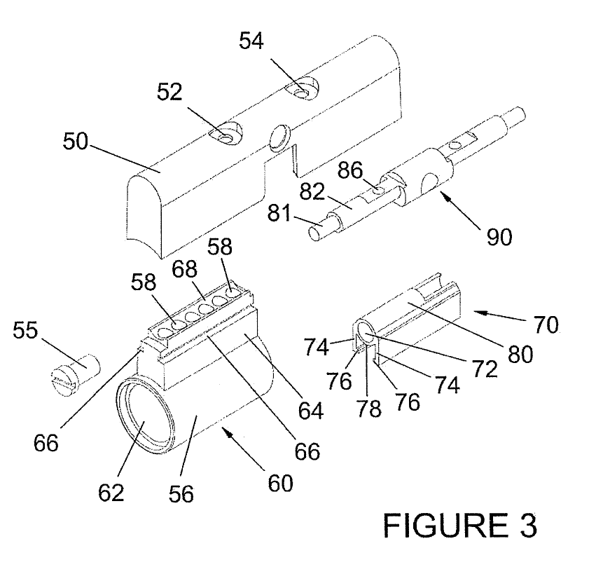

The second embodiment is shown in FIGS. 3 and 4. This embodiment can be substituted for lock body assemblies 10A and 10B, including closing off means 30 and connecting means 44 in FIGS. 1 and 2. Cap 50 is the same as in FIGS. 1 and 2. The same lock barrel 12, etc, can be used for the FIGS. 3 and 4 embodiment. Although only one lock body is shown in FIGS. 3 and 4, it is contemplated that an identical lock body will be used for the double lock barrel assembly, as in FIGS. 1 and 2.

In FIGS. 3 and 4, lock body 60 has main body 56 for receipt of a lock barrel (not shown). Lock body 60 includes six pin tumbler passages 58. Each pin tumbler passage 58 communicates with cavity 62 at its lower end and is open at its upper end.

Block 64 includes grooves 66 and arcuate channel 68. Arcuate channel 68 is considerably more shallow than arcuate channel 28 of FIG. 1.

In this embodiment, closing off means 70 has passageway 72 and arms 74. Each arm 74 ends in tongue 76, adapted to be received in groove 66. Closing off means 70 can slide onto block 64 by engagement of tongues 76 in grooves 66, as shown in FIG. 4. The lower part 78 of tube 80 enclosing passageway 72 closes off the six pin tumbler passages 58 in this configuration.

To connect to connecting means 90, cylindrical projection 82 of connecting means 90 slides into passageway 72. When cap 50 is put in place, a screw inserted through aperture 52 and aperture 86 secures the assembly. Screw 55 is secured to projection 81 of connecting means 90.

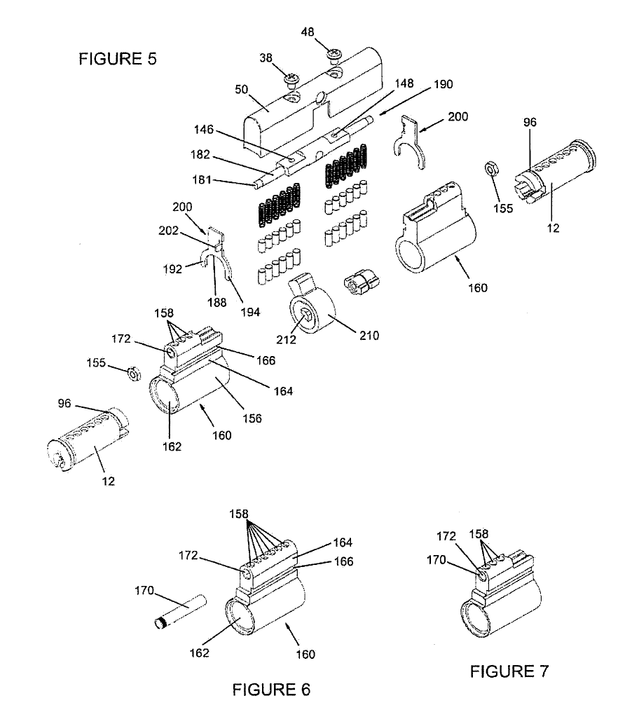

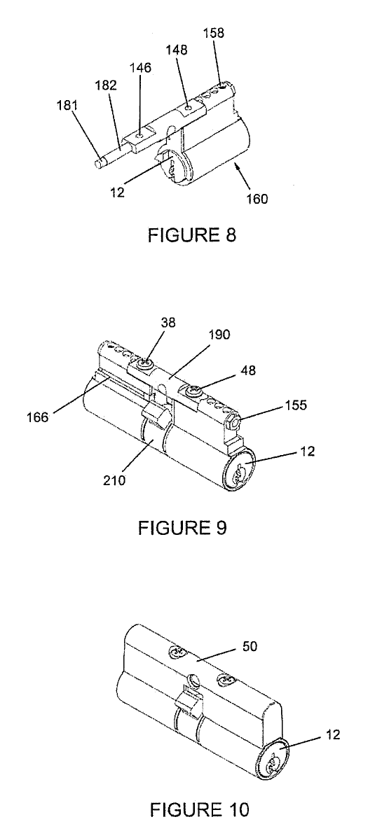

The third embodiment is shown in FIGS. 5 to 10. Cap 50 is the same as in FIGS. 1 and 2 and in FIG. 3. The same lock barrel 12 is used.

In FIGS. 5 to 10, lock body 160 has main body 156 for receipt of lock barrel 12. Lock body 160 initially includes 6 pin tumbler passages 158. Some of these are affected by machining during assembly, as explained in relation to FIG. 7, below. The pin tumbler passages 158 communicate with cavity 162 at their lower ends and are open at their upper ends.

Block 164 includes on one side groove 166 (for use in conjunction with clip 200: refer below) and is integrally formed with passageway 172. In this embodiment, closing off means 170 takes the form of a tubular insert which is inserted in passageway 172 during manufacture (refer FIG. 6).

To connect to connecting means 190, cylindrical projection 182 slides into passageway 172. When cap 50 is put in place, screw 38 is fastened into aperture 146 while screw 48 is fastened into aperture 148.

End 181 of cylindrical projection 182 contains screw threads (not shown in the figure) to hold nut 155.

As part of manufacture of this embodiment, and with reference to FIG. 6, pin tumbler passages 158 are drilled into block 164 from above, so that they communicate with cavity 162. FIG. 6 shows block 164 before insertion of tubular insert 170. With reference to FIG. 7, after tubular insert 170 is inserted into passageway 172, so as to close off pin tumbler passages 158, the sub-assembly is machined to cut away part of the top of block 164, as shown, to allow assembly of connecting means 190.

It will be seen that the third embodiment in FIGS. 5 to 10 has two other differences compared to the first embodiment in FIGS. 1 and 2. In the third embodiment, a second embodiment of clip is shown and the cam assembly is different. These are discussed further below.

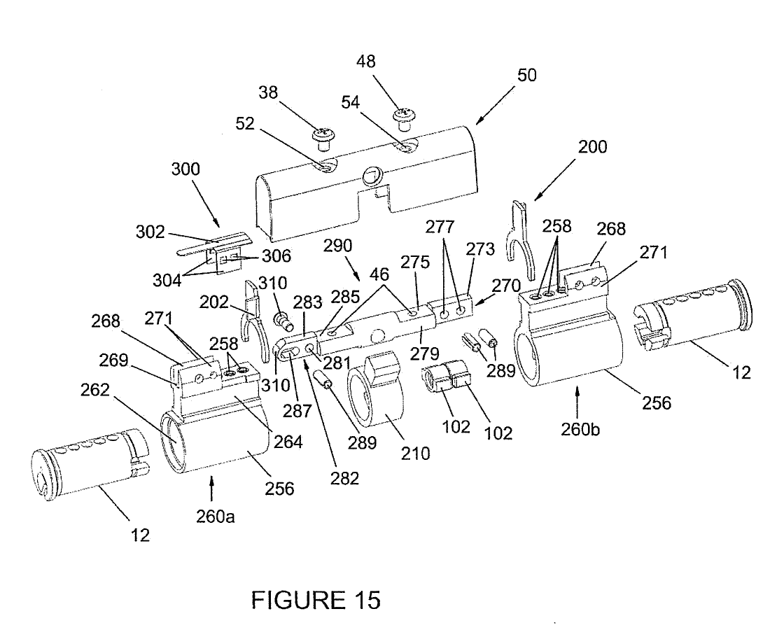

Reference is now made to the embodiment illustrated in FIGS. 15 to 18. In referring to these Figures, parts which are substantially the same as parts in the earlier figures will carry the same numerals.

Lock body 260a has main body 256 for receipt of lock barrel 12. Lock body 260a includes a number of pin tumbler passages 258. Pin tumbler passages 258 communicate with cavity 262 at their lower ends and are open at their upper ends.

Block 264 includes channel 268 with substantially flat floor 269 at right angles to channel sides 271.

Lock body 260a is similar to lock body 260b (apertures in sides 271 differ).

In this embodiment, one of the closing off means 270 is visually divided into two parts, first part 273 and second part 275. First part 273 is generally of a rectangular parallelopiped shape, with apertures 277. Second part 275 is also generally of a rectangular parallelopiped shape, except that walls 279 are arcuate. First part 273 can be regarded as being twisted through 90o compared to second part 275. First part 273 is designed to fit into channel 268 and to close off the pin tumbler passages 258 in channel 268. Second part 275 is designed to close off passages 258 which do not lie within channel 268.

In this embodiment, closing off means 270 is integral with connecting means 290, one end of which forms closing off means 270 and the other end of which forms extension 282. Like closing off means 270, extension 282 can be visually divided into two parts: part 283 and part 285, one being twisted through 90o to the other. Part 285 is identical to part 275. Part 283 is similar to part 273, except that the two apertures it contains are different from each other. One aperture 281 in part 283 is threaded to receive screw 310. The other aperture 287 is elongated, for reasons discussed below. Each of apertures 277 is designed to accommodate a roll pin 289. Elongated aperture 287 is also designed to accommodate a roll pin 289.

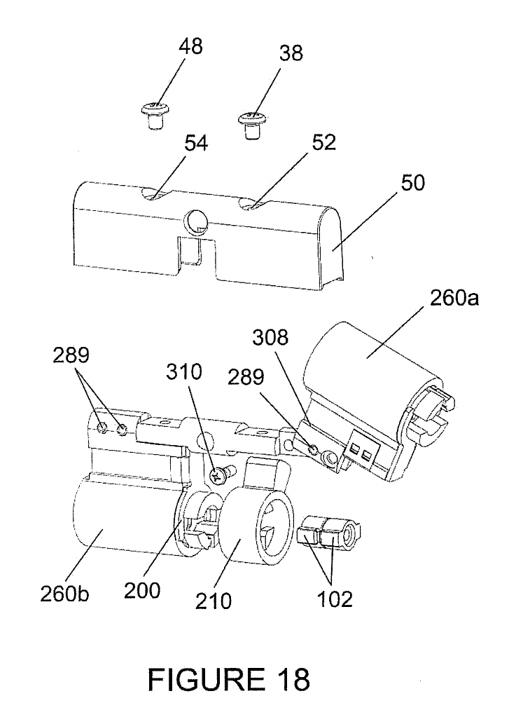

Extension 282 is capable of closing off passages 258 in main body 256. However, it is preferred that these passageways are closed off by clip 300, via flat portion 302. Clip 300 also has sides 304. In each side 304 there are punched tabs 306. Clip 300 is designed to clip onto lock body 260a (refer FIG. 18), with tabs 306 locking under ledge 308. It is intended in this embodiment that clip 300 remains in place permanently, even when rekeying lock barrel 12.

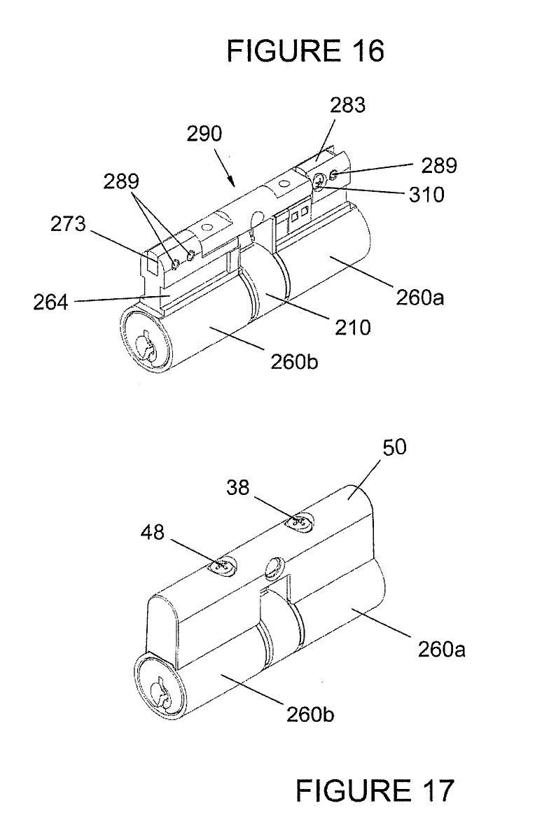

As will be appreciated from FIGS. 16 and 18, lock body 260b is retained in place in relation to connecting means 290 (and closing off means 270) by roll pins 289. Lock body 260a is partly retained by roll pin 289. However, screw 310 can be withdrawn from aperture 281 in order to dismantle the assembly.

To dismantle the assembly, screws 38 and 48 are removed and cap 50 is taken off, as shown in FIG. 18. When screw 310 is withdrawn, roll pin 289 in elongated aperture 287 can slide to the left as shown in FIG. 15. This, combined with rounded end 310 of part 283, permits lock body 260a to pivot around roll pin 289 as shown in FIG. 18. Lock barrel 12 may then be rekeyed if desired.

Referring now to FIGS. 1 and 2, these show a first embodiment of clip 100. Two clips 100 are included in the total assembly illustrated.

Clip 100 is generally “Y” shaped, having first and second arms 92 and 94 forming, together with base 88, slightly more than a semicircle designed to fit into groove 96 in each lock barrel 12 when lock barrel 12 is fully inserted into main body 14A or 14B.

Clip 100 includes projection 98. When lock barrel 12 is inserted in main body 14B, for example, groove 96 projects beyond main body 14B and arms 92 and 94 can be inserted in groove 96 in order to secure lock barrel 12 in main body 14B. Projection 98 can be manipulated to rotate clip 100 so that projection 98 is moved up into alignment with block 64. Projection 98 is held by edge 99 of cap 50, and also by flat 42 of connecting means 44.

When it is desired to remove lock barrel 12 from main body 14B, cap 50 is removed. This enables clip 100 to rotate so that projection 98 is free and clip 100 can be pulled away from groove 96. In some circumstances it may take a skilled locksmith a significant amount of time to remove a conventional circlip from engagement with a lock barrel. It will be appreciated that the clip of the present invention can greatly expedite disassembly.

Clip 200 in FIG. 5 is also generally “Y” shaped, with first and second arms 192 and 194 forming, together with base 188, slightly more than a semi circle, designed to fit into groove 96 in each lock barrel 12 when lock barrel is fully inserted into main body 156.

In this embodiment, in comparison to clip 100 in FIG. 1, clip 200 includes flange 202 on projection 198. Projection 198 operates in much the same way as projection 98 in relation to clip 100 in the first embodiment. However, flange 202 is designed to fit into groove 166 in block 164 when clip 200 is rotated as described in connection with FIG. 1. The fitting of flange 202 into groove 166 serves to lift clip 200 slightly, to alleviate friction and wear.

Also shown in FIGS. 1 and 2 is an embodiment of a cam assembly. This has inner cam part 102, in this embodiment formed of a single part with a groove 104.

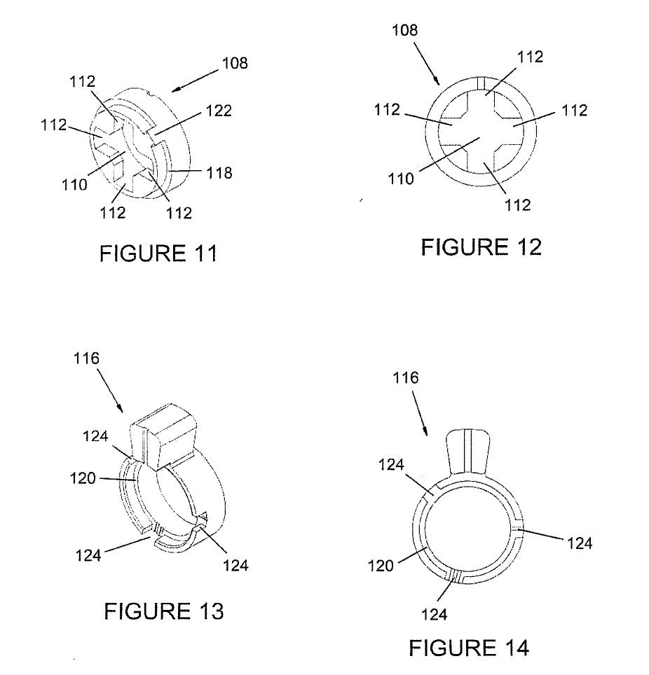

The cam assembly also has a first adjustable cam part 108 which is also shown in FIGS. 11 and 12. First adjustable cam part 108 includes conventional aperture 110 which has four branches 112. As is known, projections 114 on inner cam part 102 (see FIG. 1) can be received in an opposing pair of branches 112 and so can be received in any of four positions, each being rotated by 90 degrees from the first position.

Second cam part 116 (FIGS. 13 and 14) is designed to mate with first adjustable cam part 108, with rim 118 of first adjustable cam part 108 designed to fit into ledge 120 of second cam part 116. Shoulder 122 of first adjustable cam part 108 can be inserted in any of three recesses 124 in second cam part 116. The three recesses are located at, say, angles of approximately 110 degrees, 120 degrees and 130 degrees respectively. Consequently, it is possible to change the configuration of insertion of first cam part 108 with respect to second cam part 116 in order to alter the angles of the start position of the cam assembly, when assembled in the lock body assembly in FIG. 2.

Reference is now made to FIG. 5. While the cam assembly of FIGS. I and 2 has first adjustable cam part 108 and second cam part 116, and represents an embodiment of the third aspect of the invention, FIG. 5 has cam part 210 which does not have two cam parts 108 and 116 as in the third aspect of the invention. Cam part 210 includes four branches 212 which correspond to branches 112 in FIGS. 11 and 12. It will be appreciated that with the single cam part 210, there is no need for rim 118, ledge 120 or shoulder 122.

### INDUSTRIAL APPLICABILITY

The invention, in providing an improved lock body assembly for a double lock barrel assembly, has ready application industrially. The clip and cam assembly of the invention provide improvements and efficiencies in connection with the lock body assembly of the invention.

It will be apparent to one skilled in the art that changes may be made to the embodiments disclosed herein without departing from the spirit and scope of the invention in its various aspects.

1-19. (canceled)

20. A lock body assembly for a double lock barrel assembly, the lock body assembly including:
a) a main body for receipt of a first lock barrel;
b) a plurality of pin tumbler passages, each communicating at one end with the main body and being open at the other end;
c) means for closing off the other end of the pin tumbler passages; and
d) means for connecting the closing off means with a second closing off means for a second lock body assembly.

21. The lock body assembly of claim 20, which includes a cap.

22. The lock body assembly of claim 21, wherein the cap covers the closing off means.

23. The lock body assembly of claim 20, wherein the pin tumbler passages are contained within a block attached to or formed with the main body.

24. The lock body assembly of claim 23, wherein the pin tumbler passages communicate with a channel and the closing off means is adapted to slide into the channel.

25. The lock body assembly of claim 24, wherein the closing off means has a tongue with an aperture and the connecting means contains an aperture adapted to overlie the aperture of the closing off means.

26. The lock body assembly of claim 23, wherein the closing off means is adapted for slidable attachment to the block containing the plurality of pin tumbler passages, the closing off means being adapted to receive a projection on the connecting means.

27. The lock body assembly of claim 26, wherein the closing off means is adapted to slideably attach to the block by a pair of tongue and groove arrangements.

28. The lock body assembly of claims 20, which forms one of a pair with the second lock body assembly, the second lock body assembly having features (a), (b) and (c) of the lock body assembly of claim 20.

29. A clip for securing a lock barrel in the lock body assembly of claim 20, the lock barrel being adapted for receipt within a main body of the lock body assembly, the lock barrel including a peripheral channel adapted to receive the clip when the lock barrel in inserted in the main body, wherein the clip includes an extension for rotating the clip between a first position in which the extension protrudes from the body and a second position in which the extension does not so protrude.

30. The clip of claim 29, wherein the clip includes first and second arms.

31. The clip of claim 30, wherein the clip includes a flange adapted to fit into the main body.

32. A cam assembly for the lock body assembly of claim 30, the assembly including:
a) a first adjustable cam part; and
b) a second adjustable cam part adapted for engagement with the first adjustable cam part;
either the first or the second adjustable cam part including latch actuation means, wherein the first adjustable cam part is capable of assembly in more than one configuration in relation to the second adjustable cam part.

33. The lock body assembly of claim 20, wherein the means for connecting the closing off means with the second closing off means for the second lock body assembly is integral with the closing off means and/or the second closing off means.

34. The lock body assembly of claim 20, wherein the main body is adapted for pivotal connection with the closing off means or the connecting means.

35. A lock body assembly substantially as herein described with reference to FIGS. 1 and 2 or 3 and 4 or 5 to 10 of the accompanying drawings.

36. A clip for securing a lock barrel in a lock body assembly substantially as herein described with reference to FIG. 1 or 5 of the accompanying drawings.

37. A cam assembly for a lock body assembly substantially as herein described with reference to FIGS. 1, 11, 12, 13 and 14 or to FIG. 5 of the accompanying drawings.

38. A lock body assembly substantially as herein described with reference to FIGS. 15 to 18 of the accompanying drawings.
